(19) United States
(12) Patent Application Publication
(10) Pub. No.: US 2026/0203781 A1
(43) Pub. Date: Jul. 16, 2026

(54) System And Method For Generating Individually Tailored Responses

(71) Applicant: Edmond Kwan, Cupertino, CA (US)

(72) Inventor: Edmond Kwan, Cupertino, CA (US)

(21) Appl. No.: 19/393,511

(22) Filed: Nov. 18, 2025

Related U.S. Application Data
(60) Provisional application No. 63/721,578, filed on Nov. 18, 2024.
(60) Provisional application No. 63/752,857, filed on Feb. 2, 2025.

(51) Int. Cl. G06Q 30/0203

(52) U.S. Cl. CPC G06Q 30/0203

(57) ABSTRACT

A method for participants to take advantage of AI to expedite entries analysis and individually tailored messaging at scale on the participants'vision. Historically, using education as an example, analyzing entries and providing individually tailored responses for entries to students at scale was time-consuming and impractical. This invention revolutionizes the process. The method comprises (a) creating questionnaires by transforming response drafts into questionnaires, allowing participants to transform the response drafts to submit parts or all portions of the response drafts to one or more AI-analysis, and (b) once the questionnaires are completed, users can use them to generate responses expeditiously. These responses can then be merged with students'credentials and entries to produce individually tailored messaging at scale rapidly.

### CROSS-REFERENCE TO RELATED APPLICATIONS

This application claims priority to and the benefit of the provisional patent application titled “System and Method For Allowing Generation of Individually Tailored Messages Efficiently”, application number 63/721,578, filed in the United States Patent and Trademark Office on Nov. 18, 2024. This application also claims priority to and the benefit of the provisional patent application titled “System and Method For Allowing Generation of Individually Tailored Messages Efficiently”, application number 63/752,857, filed in the United States Patent and Trademark Office on Feb. 2, 2025. The specifications of the above-referenced patent applications are incorporated herein by reference in their entirety.

The following lists the meanings of some terms as used herein:

AI: Artificial intelligence.

AI-generated: The participant can edit AI-generated content.

AI-analysis: As used herein, AI-analysis refers to a set of one or more operations invoked by the enterprise solution system to process, interpret, analyze, transcribe, and/or transform input data in support of grading, assessment, or instructional workflows. AI-analysis encompasses all AI-related functions described in this patent application, including but not limited to grading, classification, rubric management, response generation, error detection, transformation of input formats, confidence estimation, condition and script generation. They can be transformed by suggesting various modifiable questions or conditions that better suit different recipients receiving the response. These operations are accessed via one or more application programming interfaces (APIs), user interfaces (UIs), command-line interfaces (CLIs), graphical interfaces, messaging protocols, or any other mechanism that enables invocation, execution, or interaction with said operations, whether internal or external to the enterprise solution system. The scope of AI-analysis is intended to cover all embodiments, use cases, and functional variations described herein, including future extensions that rely on AI-based logic to perform any portion of the grading workflow.

Collaboration community: Transferring information between users via an enterprise solution or enterprise software solution.

Conditions: Descriptions of multiple-choice formats, where users can make one or more selections.

Dynamic variable: Represents the AI-generated content returned.

Enterprise solution: A software solution that improves productivity and can be used by more than one person.

Entries: Written and/or verbal submissions provided by the recipients, including but not limited to documents, videos, essays, messages, assignments, emails, etc.

Functional area: Any entity, a classroom or a department within the school or an entity.

Grammar: A specific condition is predetermined; the enterprise solution system automatically selects the appropriate option from the available choices, including but not limited to dynamic variables, name, gender, gender-specific grammar, recipient-related grammar, and entries-specific information.

Individually tailored message or response: A communication constructed based on recipient-specific data, conditions, or context, such that the resulting message reflects individualized logic beyond static template substitution. This includes, but is not limited to, dynamically generated messages, AI-assisted outputs, or rule-based constructions that adapt to recipient attributes, in contrast to systems like MS-Mail Merge that vary only predefined fields within a fixed template.

Network Interface: A network interface is a point of connection between a computer, for example, the enterprise solution system, and a network. The network interface can be a physical component like a Network Interface Card (NIC) or a software-based one, such as a loopback interface.

Network: A network is a group of interconnected devices that can communicate and share resources. The types of network comprise a Local Area Network (LAN), a Cellular Network, and a Wide Area Network (WAN) providing internet access.

Participants and Privileged participant: Anyone who uses the enterprise solution system in preparing a response.

Participant communication device and Recipient communication device comprise a smartphone, a computer, a tablet computer, etc.

Questionnaire: A structured or semi-structured set of data records and/or instructions, configured for use by a participant to generate or guide the generation of individually tailored responses or messages for recipients, based on selected content, modifiable conditions, or contextual logic

Recipients: Those who will receive a response from the questionnaire user.

Response or response messaging: any reply, reaction, or submission generated by a recipient in relation to an entry, prompt, or stimulus. A response may be written, verbal, visual, or multimodal, and may include but is not limited to: documents, essays, messages, assignments, emails, videos, audio recordings, images, annotations, gestures, selections, or structured data inputs. Responses may be free-form or templated, synchronous or asynchronous, and may reflect intent, opinion, evaluation, inquiry, or engagement. The term encompasses both original content and modifications of prior content, regardless of format or medium.

Script or script message: A constructed expression, message, or instruction. When generated in response to a condition, the script reflects logic derived from—but it is not identical to—the condition.

Service provider: A company that provides enterprise software solutions or enterprise solution accounts to individuals, businesses, and other groups.

Student: The student's custodian, such as a parent or guardian or a student.

User: A participant.

### FIELD OF THE INVENTION

The present invention in general relates to a method and system provided by a service provider for enhancing the productivity of a participant. More specifically, the invention pertains to a service-based infrastructures and operational techniques through which a service provider enables a participant to analyze entries —-such as written or verbal submissions, including but not limited to documents, essays, messages, assignments, emails, etc., provided by the recipients. The system facilitates the generation of individually tailored responses from participants to recipients within a collaboration community. Participants use the system via an internet-based platform hosted by the service provider, enabling collaborative engagement among all parties within the community.

### BACKGROUND

Presently, participants, who can be any person, like to quickly analyze all the entries and generate individually tailored responses to a group of recipients, who can be any person. While it is technically possible for participants to manually review all the assignments and generate individually tailored responses to each of the assignments, doing so in a timely and scalable manner is impractical without AI assistance. The volume, diversity, and time sensitivity of submissions often exceed what participants can manage unaided, making intelligent assistance essential for sustaining responsiveness and quality. Furthermore, there are two fundamental problems here. First, how does one quickly analyze all the incoming entries? Second, how can participants quickly provide individually tailored responses? Artificial intelligence (AI) can automate message analysis, but may not always base the analysis on the participant-directed content composition. From the participant's point of view, the AI's analytical result may not always be reasonable, even if a benchmark is provided. In addition, AI may not always speak on behalf of the participant. Companies like Microsoft Inc. offer products like mail merge, where a message is merged with different individuals'credentials to produce individualized messages. However, these messages are identical, except the individual credentials are different. With the advent of AI, AI-powered message analysis is now possible, though it may not always be reliable. AI-powered responses for individually tailored response are still not expected to be always reliable. Therefore, recipients should not rely on AI to analyze incoming entries and respond accurately on their behalf unless the AI is provided with accurate input information, which is extremely challenging to ensure.

To illustrate this pervasive problem, education will be considered for ease of illustration. Although everyone agrees that insightful, distinctive, and individually tailored response is crucial in education, and despite recognizing its apparent value, most educators dismiss it as unrealistic due to its significant time demands on educators.

Even with the advent of AI, AI-generated response represents an educator's own experience and feelings, which has proven challenging. In a school environment, for example, the educator is often the only person who knows what was taught in the class, what assignments were given to the students, what discussions occurred during the class, and a particular student's behavior. Often, the educator alone is the most suitable person to address these areas. In other words, without access to the educator's perspective, AI-generated response would struggle to accurately reflect the educator's viewpoint. So, one should use AI to enhance the participant's ability to generate individually tailored response, rather than expecting AI to accurately respond on their behalf. The inventive concept disclosed herein describes a system that involves AI-generated and/or non-AI-generated content. This combined facility enables AI-powered analysis and individually tailored response messaging to be used at scale.

Therefore, there is a long-felt but unresolved need for a system and a method that one can rely on to efficiently produce AI-powered analysis and individually tailored response messaging at scale. There is also a long-felt but unresolved need for a non-AI-powered system and a method for integrating a response draft into a questionnaire and using the questionnaire to help generate an individually tailored response to the recipient.

### SUMMARY OF THE INVENTION

The method and system disclosed herein address the aforementioned long-felt but unresolved need for a system and a method that participants can rely on to efficiently produce AI-powered analysis and individually tailored response messaging in the participants-directed content composition at scale. AI can be deployed to help expedite the process. The method and system disclosed herein also address the aforementioned long-felt but unresolved need for a non-AI-powered system and a method for integrating a response draft into a questionnaire and using the questionnaire to help generate an individually tailored response in the participant-direct content composition to the recipient. This summary is provided to introduce concepts in a simplified form that are further disclosed in the detailed invention description. This summary is not intended to determine the scope of the claimed subject matter.

The method of transforming a response draft into a questionnaire is performed by an enterprise solution system comprising one or more processors and a memory. The memory stores multiple instructions. The instructions stored in the memory are computer programming instructions. The instructions, upon execution by the one or more processors, can cause the processor to perform various method steps. The method comprises accepting input content corresponding to a whole or a partial part of the response draft for transformation into the questionnaire. In an embodiment, the input content is accepted from a participant for transformation into the questionnaire.

In one or more embodiments, the transformation may be performed using AI-based techniques configured to interpret, restructure, or reframe the input content

The questionnaires serve as tools that allow users to do the analysis of entries and generate responses with individually tailored response messaging at scale. The questionnaire can be used to generate responses to the recipients at scale efficiently. The response messaging facilities allow the participants to merge individually tailored response messaging with recipients'credentials at scale. AI can be deployed to expedite this process.

The method further comprises providing the input content at one of multiple levels of granularity. The enterprise solution system receives the provided content at one of the levels of granularity. For example, the enterprise solution system may receive a sentence, two or more sentences, a paragraph or the entire response draft. The method further comprises obtaining one or more modifiable conditions based on the provided content. In an embodiment, obtaining one or more modifiable conditions comprises transforming the provided content into the one or more modifiable conditions in the questionnaire. AI can be deployed to expedite the transformation by submitting parts or all portions of the response draft to various AI tools.

The participant is enabled to select one or more modifiable conditions to generate individually tailored responses. AI analysis are tasked with analyzing the unique characteristics of a particular context in the response draft. They can be transformed by suggesting various modifiable questions or conditions that better suit different recipients receiving the response. The method further comprises providing a plurality of modifiable scripts, each correlated to a respective one of the one or more modifiable conditions. The method further comprises enabling the participant to select applicable modifiable conditions to generate individually tailored responses.

A method of using the questionnaire to generate an individually tailored response to a recipient is also provided. This method comprises receiving recipient entries originating from the recipient. To achieve this, a questionnaire configuration module is provided which is configured to receive the recipient entries originated from the recipient. Then, a request is made to provide the content for the response. For example, the participant is requested via the questionnaire to either provide or transfer the content for the response. Afterwards, one or more entries are received, via a user interface of a recipient communication device. In an embodiment, the one or more entries received from the recipient are uploaded to the enterprise solution system by the participant via a user interface of a participant communication device. The one or more entries uploaded are processed using an AI-analysis configured to evaluate content. Thereafter, a response corresponding to the one or more entries is generated. In an embodiment, the response generated is a grading output. Thereafter, a request is made via the questionnaire to determine if it is necessary to integrate and where in the questionnaire to integrate the recipient-related grammar, one or more dynamic variables, the supplemental information, and/or the AI-generated content into any type of the modifiable script. In an embodiment, the request made above via the questionnaire is made to the participant or the enterprise solution system. Finally, the individually tailored response to the recipients is generated.

Participants can edit all content, ensuring the response reflects the participants'perspectives.

### BRIEF DESCRIPTION OF DRAWINGS

The foregoing summary and the following detailed invention description is better understood when read in conjunction with the appended drawings. For illustrating the invention, exemplary constructions of the invention are shown in the drawings. However, the invention is not limited to the specific methods and components disclosed herein. The description of a method step or a component referenced by a numeral in a drawing applies to the description of that method step or component shown by that same numeral in any subsequent drawing herein.

FIG. 1A exemplarily illustrates a method of integrating a response draft into a questionnaire.

FIG. 1B exemplarily illustrates a method of using the questionnaire to generate an individually tailored response to a recipient.

FIG. 2 exemplarily illustrates an enterprise solution system for transforming the response draft into the questionnaire.

FIG. 3 exemplarily illustrates a response draft.

FIG. 4 exemplarily illustrates a screenshot illustrating that an assignment can be submitted for AI analysis in a questionnaire.

FIG. 5 exemplarily illustrates a screenshot illustrating that AI-generated content can be edited by the participant in a questionnaire.

FIG. 6 exemplarily illustrates a screenshot illustrating that AI-generated content can be incorporated into a non-AI-generated scripted message in the questionnaire.

FIGS. 7A and 7B exemplarily illustrate screenshots that illustrate that AI can convert a provided description on the response draft to questions, conditions, and scripted messages based on the response draft provided by the participants.

FIGS. 8A-8C exemplarily illustrate screenshots that illustrate the enterprise solution system generating a response comprising an AI-generated script, AI-generated assignment analysis results, and a non-AI-generated script.

FIG. 9 exemplarily illustrates a screenshot of a system comprising an item with different conditions assigned with a correlated scripted message in a questionnaire.

FIGS. 10A-10B exemplarily illustrate a screenshot of a system comprising a feature allowing users to select the most applicable condition to invoke its corresponding scripted message based on their personal assessment, aided by an AI-analyzed assignment in a questionnaire.

FIG. 11 exemplarily illustrates a screenshot of a scripted message editor inside the questionnaire editor that facilitates a grammar facility.

FIG. 12 exemplarily illustrates a screenshot of a questionnaire that illustrates that users can select the exception function by designating which recipients apply to a particular tailored of conditions, whether AI-generated or non-AI-generated.

FIGS. 13A-13B exemplarily illustrate a response, which is a scripted message generated by a selected condition in a questionnaire.

FIGS. 14A-14B exemplarily illustrate a response draft that can be transformed into a questionnaire by a function (e.g., build editor) expeditiously with the help of AI.

FIG. 15 exemplarily illustrates that an AI analysis function, performed by an AI-analysis, successfully transcribes an uploaded video assignment when a questionnaire is executed, paving its way to further AI analysis.

FIG. 16 exemplarily illustrates that participants prepare recipients'credentials, which are merged with a questionnaire to produce enhanced, individually tailored response messaging.

FIG. 17 exemplarily illustrates that a participant submits the assignment benchmark during the questionnaire execution in the enterprise solution system for AI analysis.

FIG. 18 exemplarity illustrates that a benchmark configurator is facilitated for the user to configure a benchmark for AI analysis.

### DETAILED DESCRIPTION OF THE INVENTION

Participants would be better served if a service provider could provide an online enterprise software system solution to effectively and efficiently collaborate with all members within their participant communities to achieve streamlined student response communication. The prerequisite for participants is used as an example to share internal information with recipients to provide rapid AI-powered analysis and individually tailored responses at scale on entries. These assignments can come in any format, such as PDF, MP4, Doc, text, etc. This software can be used in any functional area. While there are experienced heads of functional areas, others need handholding at every step of the way. For example, the school leaders need a system to optionally define the best management experience so that the heads of functional areas can adhere to it to produce consistent AI-powered, individually tailored responding messaging at scale, or the school leader can relinquish this capability of defining the best management experience to his experienced staff. Nevertheless, this system, capable of producing AI-powered analysis and individually tailored responding messaging at scale, is required.

Participants can establish the best management practice by designing questionnaires based on their response draft. This draft can be non-AI produced, as it is still difficult for the current AI technology to produce personal experiences.

Conventional management records mainly include quantitative items such as recipients'scores, grades, status, and attendance. Insightful management should consist of everyone's perspective. Some of these non-quantitative expressions require descriptions. The challenge is how to generate and collect this information efficiently, given that the heads of the functional areas, for example, the classroom teachers, are already very busy managing the functional areas. AI can be deployed to expedite grade assignments and create questionnaires containing AI-generated questions, conditions, dynamic variables, and scripts. The heads of the functional areas, a school principal, inadvertently produced a consistent classroom management quality standard accepted by the school leaders with enormous productivity.

Systems and methods, according to some embodiments of the present invention, allow participants to use AI to help expedite design or modify response-driven questionnaires for heads of different functional areas, such as classroom teachers. The functional areas comprise the classroom or the department within the school

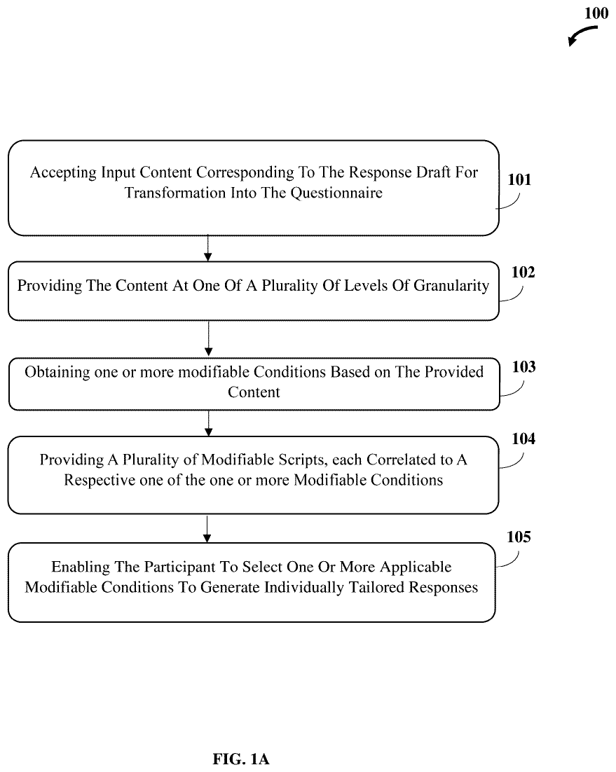

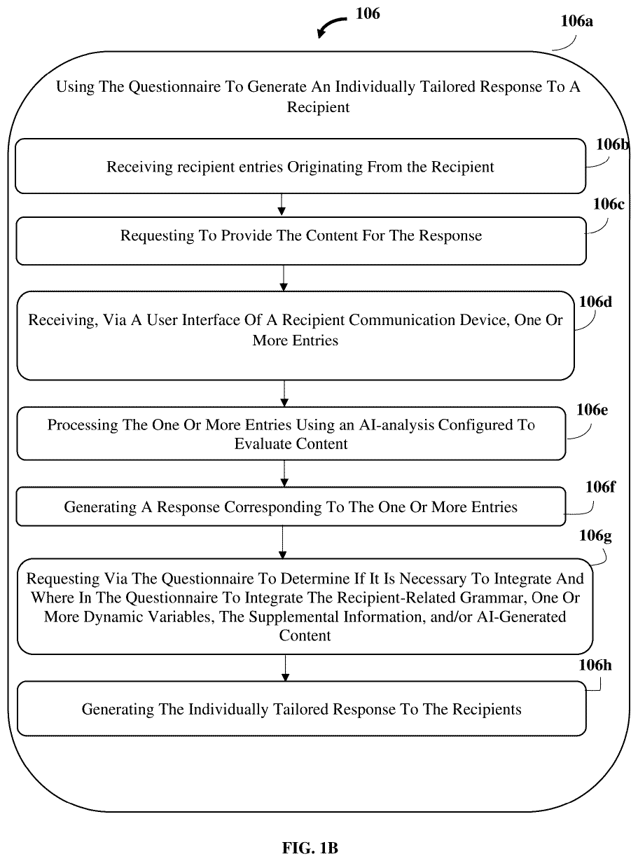

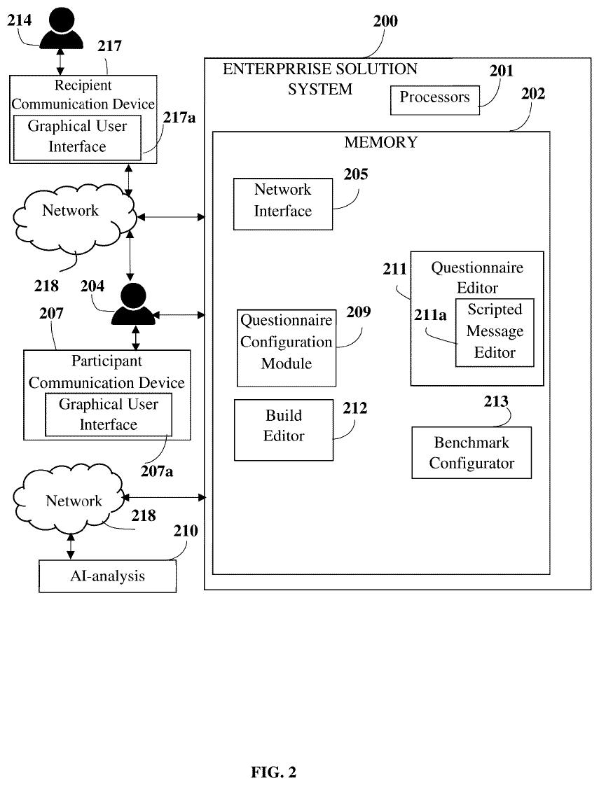

FIG. 1A exemplarily illustrates a method 100 of transforming a response draft into a questionnaire. FIG. 2 exemplarily illustrates an enterprise solution system 200 for transforming the response draft into the questionnaire. The method 100 of transforming a response draft into the questionnaire is performed by the enterprise solution system 200 that comprises one or more processors 201 and a memory 202. The memory 202 stores multiple instructions that are computer programming instructions. The processor 201 executes programming instructions stored in the memory 202. The instructions, upon execution by the one or more processors, can cause the processor 201 to implement the steps of the method 100. In an embodiment, the AI-analysis 210 implements several steps, for example, steps 103 and 104 of the method 100 and steps 106e, 106f and 106h of the method 110 upon execution of the instructions by the processor 201. The method 100 comprises accepting 101 input content corresponding to a whole or a partial part of the response draft. In an embodiment, the input content is accepted from a participant 204 for transformation into the questionnaire. In an embodiment, the enterprise solution system 200, accepts the input content corresponding to the response draft from the participant as media content.

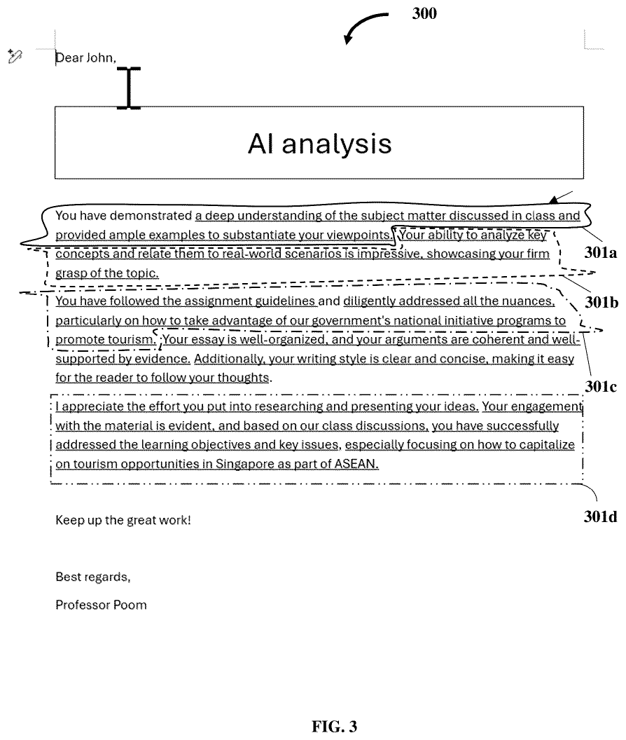

FIG. 3 exemplarily illustrates the response draft 300. The participant 204 may input or upload the content corresponding to the response draft 300 to the enterprise solution system 200 via a participant communication device 207 as shown in FIG. 2. In an embodiment, the participant communication device 207 may host the enterprise solution system 200 in his device, or have access to a system that is connected to the enterprise solution system 200 via a network 218 or cloud. The participant communication device 207 comprises a user interface, for example, a graphical user interface 207a, as shown in FIG. 2, to input or upload the content corresponding to the response draft 300 to the enterprise solution system 200 and to receive output.

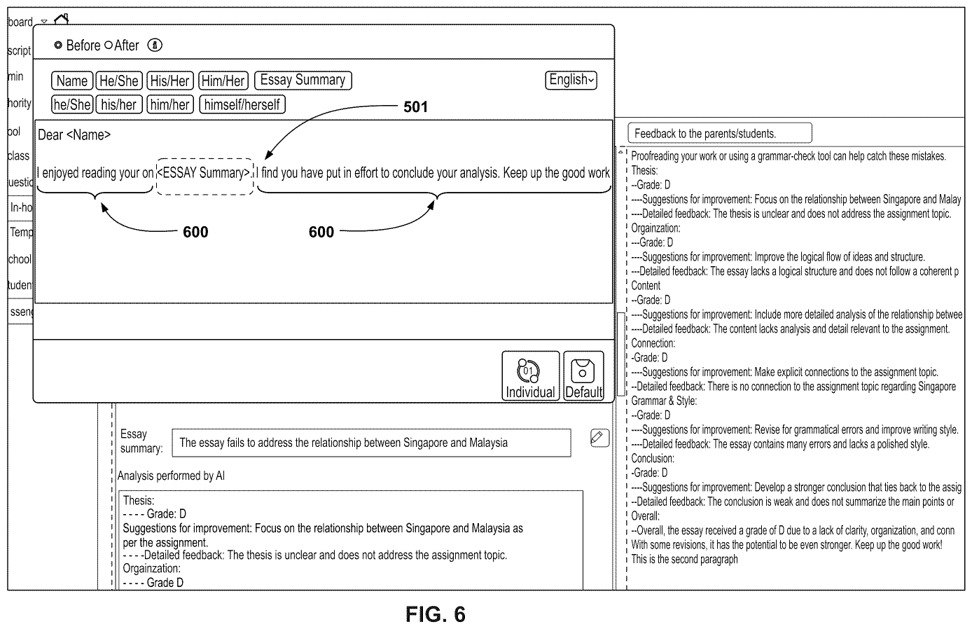

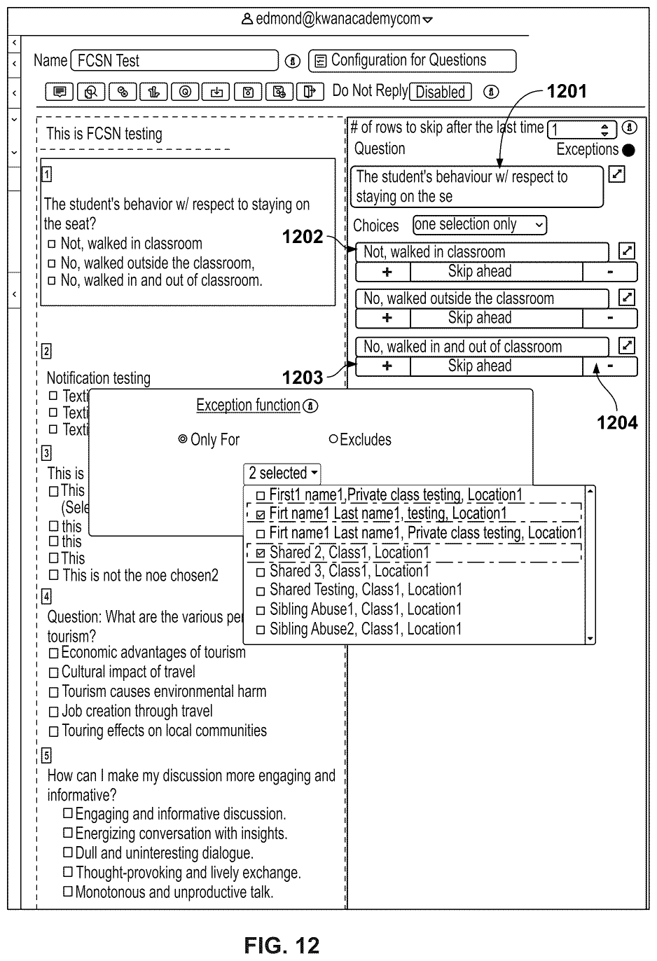

The method 100 further comprises providing 102 the input content at one of a multiple of levels of granularity. The enterprise solution system 200 receives the input content. As shown in FIG. 3, an embodiment, the content corresponding to the response draft 300 may comprise one or more response statements 301a, 301b and 301c. As shown in FIG. 12, the response draft may also be input a portion at time. A whole or a partial part of the draft may be input to the field 1201 shown in FIG. 12. The enterprise solution system 200 may receive the whole or the partial part of the input content corresponding to the response draft 300. Input content received by the enterprise solution system 200 is provided by the participant 204 via a participant communication device 207 connected to the enterprise solution system 200 via a network 218. The enterprise solution system 200 comprises a network interface 205 to connect to the network 218. The input content provided by the participant 204 comprises a sentence 301a, 301b or 301c, a paragraph 301d, the entire response draft 300, a combination of sentences 301a, 301b and 301c, or a combination of sentences 301a, 301b and 301c and the paragraph 301d which each represent a granularity level. The participant 204, uses the method 100 and the enterprise solution system 200 disclosed herein to transform the response drafts, for example, shown in FIG. 3, into a questionnaire. Each of the questionnaires serve as tools that allow participants 204 to do the analysis of entries and generate individually tailored response messaging at scale. Each questionnaire may consist of AI or manual analysis, AI-generated or manually input questions, AI-generated or manually input conditions 1203, shown in FIG. 12, AI-scripted or manually input messages, AI or manual grammar detection, dynamic variables, etc.; users can optionally create these contents not using AI. Each question or instruction can contain conditions to handle different scenarios. Scripts or scripted messages can be paired with some AI-generated or non-AI-generated conditions, as shown in FIG. 6. Scripts or scripted messages can be AI-generated, or non-AI-generated. Within a questionnaire, items can be either non-AI-generated, AI-generated or a mixture of both.

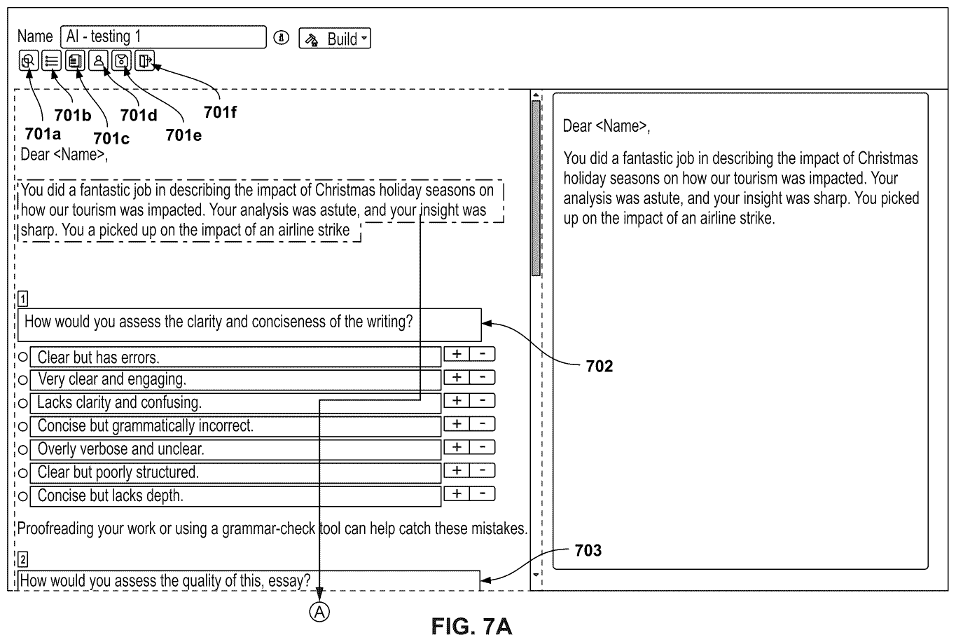

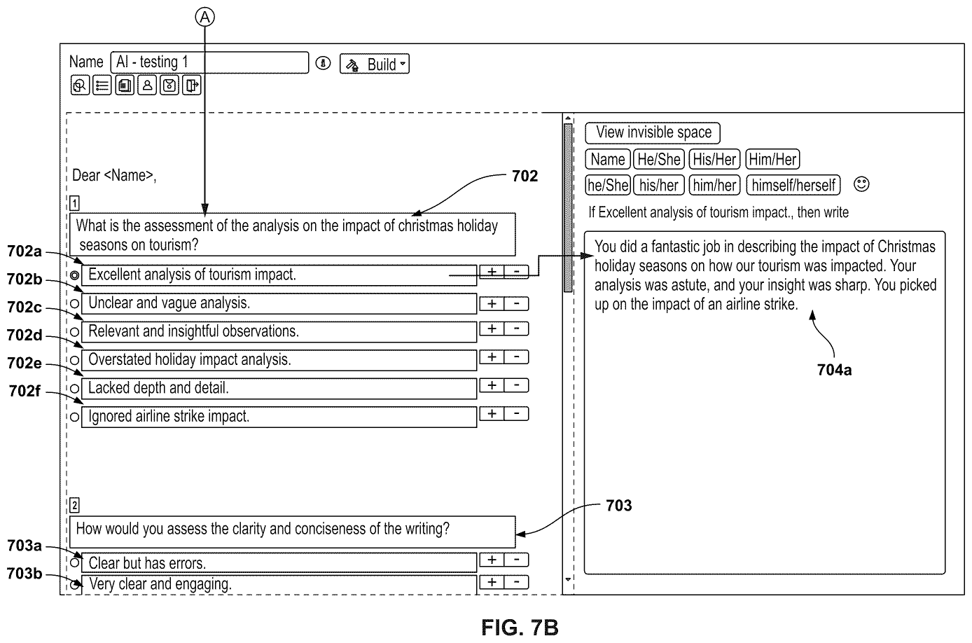

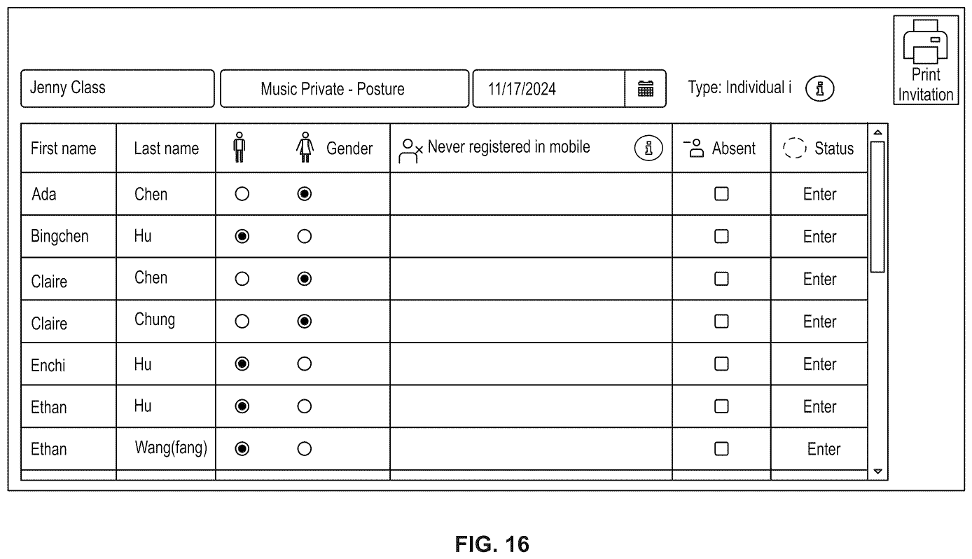

The enterprise solution system 200 further provides multiple response messaging facilities 701a, 701b, 701c, 701d, 701e, and 701f as shown in FIG. 7A. In an embodiment, one of the response messaging facilities 701a, 701b, 701c, 701d, 701e, or 701f allows the participants 204 to merge individually tailored response messaging with recipients'credentials at scale, as shown in FIG. 16. AI can be deployed to expedite this process. The method 100 further comprises obtaining 103 one or more modifiable conditions based on the provided content. In an embodiment, obtaining one or more modifiable conditions comprises transforming the provided content into the one or more modifiable conditions in the questionnaire. In an embodiment, the step of transforming the provided content into the one or more modifiable conditions in the questionnaire comprises the option to modify the one or more modifiable conditions by the participants by providing inputs to the enterprise solution system 200 via a participant communication device 207.

As mentioned above, the content corresponds to the response draft received from the participant 204. In an embodiment, the response draft 300 is non-AI produced, as it is still difficult for the current AI technology to produce personal experiences. In an embodiment, the response draft 300 is prepared by a participant 204. In an embodiment, the content of the response draft 300 can comprise one or more response statements 301a, 301b and 301c, as shown in FIG. 3. Each response statement in the questionnaire provides response about at least one of a plurality of aspects of an entry provided by a recipient 214. The aspects of the entry provided by the recipient 214 comprise structural aspect, functional aspect, content aspect and style aspect of the entry. The aspects of the entry received form the recipient 214 may further comprise word choice, flow, evidence and support, tone, style, grammar, spelling, format, and design. In an embodiment, the response draft 300 is one of a written critique, a review, an assessment, or a critical analysis that provides an evaluation of the entry received form the recipient 214 and can be based on specific criteria of the entry received form the recipient 214. FIGS. 7A and 7B exemplarily illustrate screenshots that illustrate that AI can convert a provided description in the response draft to questions based on the response draft, for example, response draft 300, shown in FIG. 3, provided by the participants. As shown in FIGS. 7A and 7B the AI, for example, the AI analysis 210 shown in FIG. 2, converts the provided description 301a and 301b in the response draft 300 to questions 702, 703 based on the response, modifiable conditions (modifiable conditions 702a-702f corresponding to question 702, and modifiable conditions 703a-703b corresponding to question 703), and scripted messages 704a corresponding to modifiable condition 702a of question 702. As shown in FIG. 7A, AI converted a provided description, for example, 301a in FIG. 3, to a question, for example, 702, with various modifiable different outcomes, for example, six (6) modifiable conditions 702a-702f, for selection. As shown in FIG. 7B, each outcome for example, modifiable condition 702a, has an AI-generated modifiable script 704a.

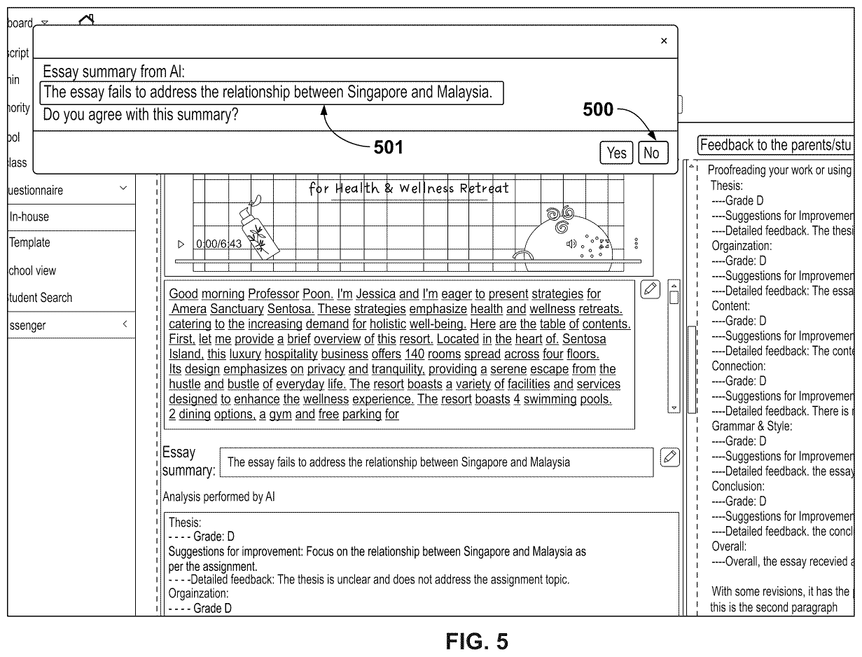

The step of transforming the provided content into the one or more modifiable conditions comprises enabling participant modification of the modifiable conditions. The enterprise solution system 200 may allow the participant to modify, add or delete the modifiable conditions 702a-702f and 703a-703b. Furthermore, the participant is allowed to modify, add, and/or delete each of the correlated scripts, for example, modifiable script 704a, for consistency with its modifiable conditions, for example, modifiable condition 702a. In an embodiment, the participants 204 can edit, add or delete all content, ensuring the response reflects the participants'perspectives. If the participant 204 staff feels he can improve the AI-generated content, he can edit and will prevail over AI-generated content. FIG. 5 exemplarily illustrates a screenshot illustrating that AI-generated content can be edited by the participant 204 in a questionnaire. If the participant 204 is unsatisfied by the AI-generated content, for example, an essay summary is now a dynamic variable 501, the participant 204 can press the “No” button 500 and edit the essay summary. In an embodiment, the participant 204 may provide inputs via the participant communication device 207 for enabling participant modification of the one or more modifiable conditions. The enterprise solution system 200 may receive the inputs from the participant via the participant's communication device 207.

The method 100 and the system 200 may utilize AI-analysis 210. Some AI-analysis 210 are tasked with analyzing the unique characteristics of a particular context, to be provided by the participants 204 in the response draft 300. The particular context can be transformed by suggesting various modifiable questions or conditions that better suit different recipients 214 receiving the response. Additionally, AI-analysis 210 can suggest correlated AI-generated scripted messages for these suggested outcomes. This process can be done without AI, except it will take longer.

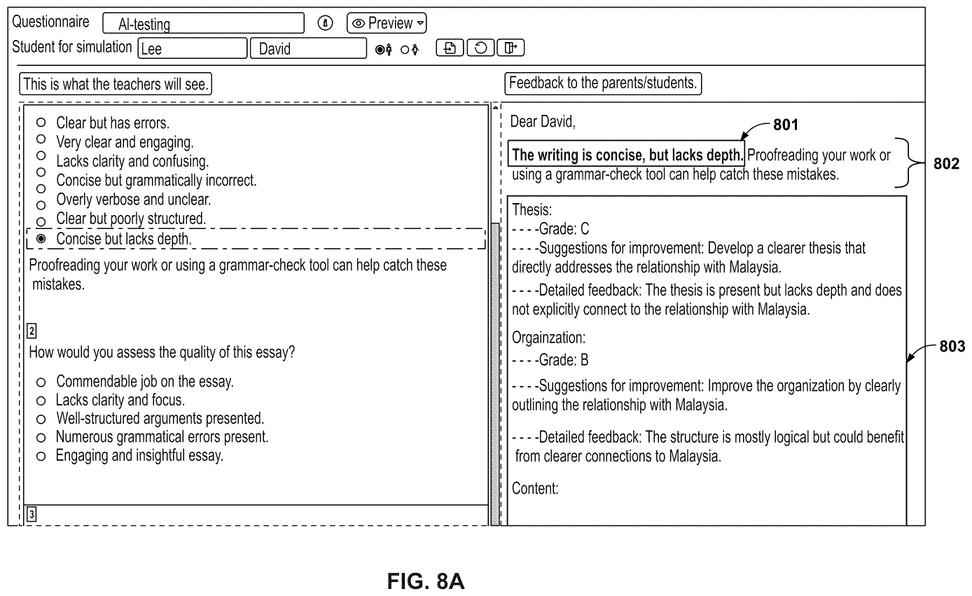

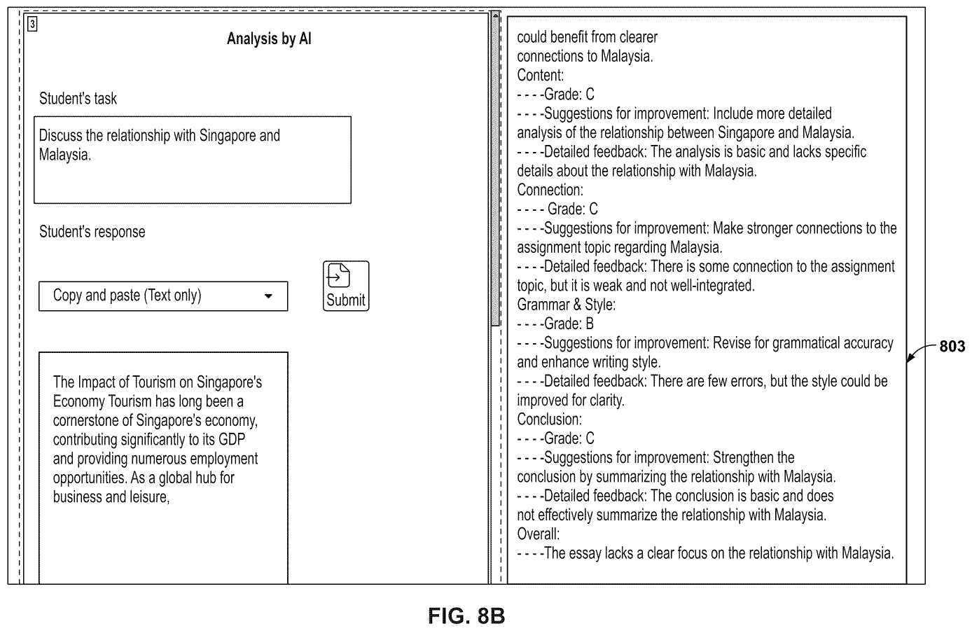

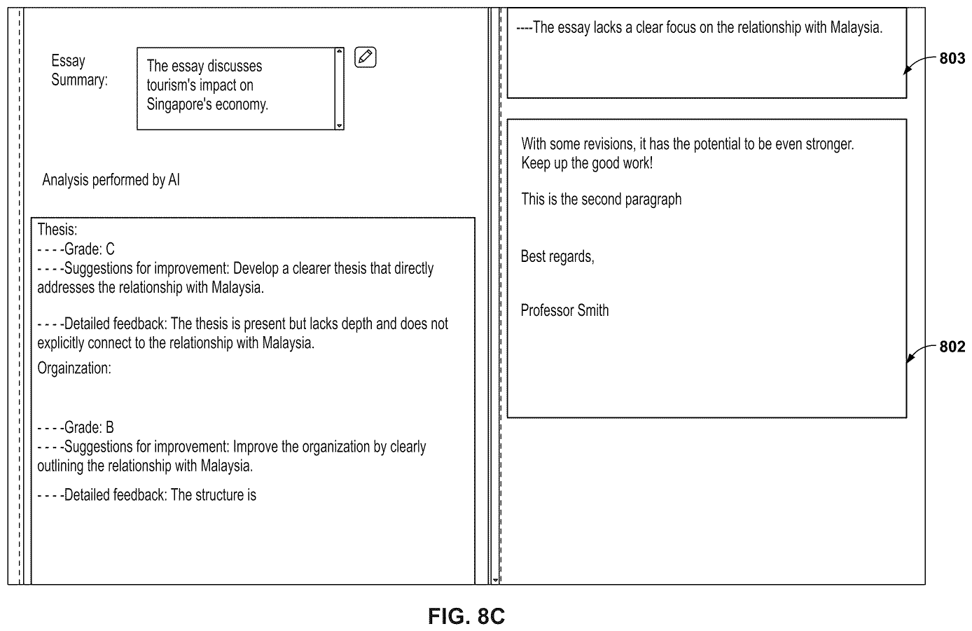

The questionnaire can prompt the users to do an analysis of the entries against benchmark provided. AI can be deployed via the AI-analysis 210 for AI analysis of entries against the benchmarks provided for higher efficiency. Analysis results can be incorporated into either non-AI-generated or AI-generated responses. In an embodiment, the benchmark comprises one of a plurality of scoring guides to evaluate the quality of the individual's to the given topic. An example of a scoring guide comprises “Rubric” which is used in the realm of US education as a “scoring guide used to evaluate the quality of students' constructed responses” according to James Popham. FIGS. 8A-8C exemplarily illustrate screenshots that illustrate the enterprise solution system generating a response comprising an AI-generated script 801, AI-generated assignment analysis results 803, and a non-AI-generated script 802.

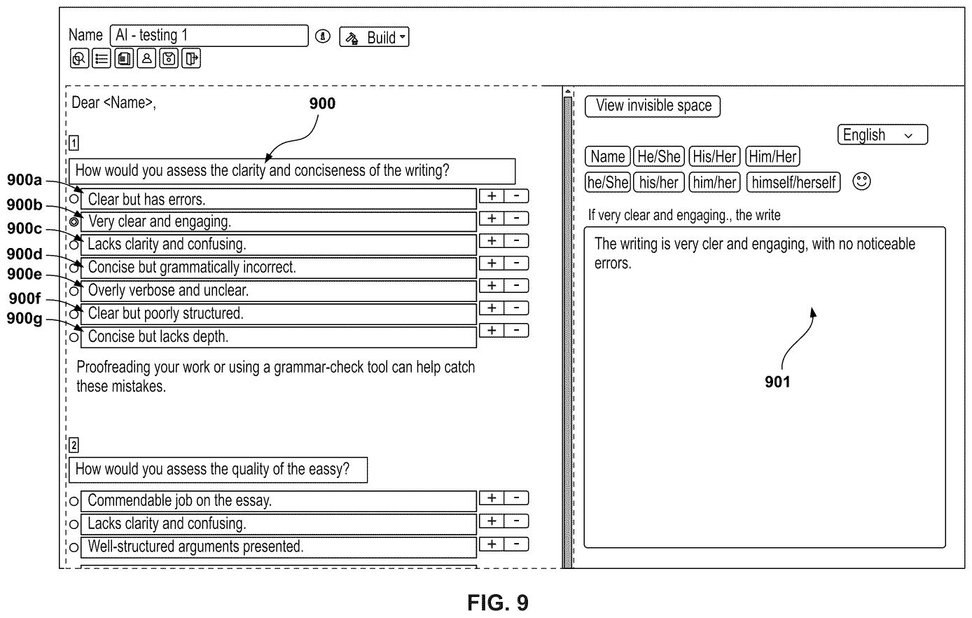

The method 100 further comprises providing 104 multiple modifiable scripts, each correlated to a respective one of the one or more modifiable conditions. FIG. 9 exemplarily illustrates a screenshot of a system comprising an item, for example, a question 900 with different modifiable conditions 900a-900g. As shown in FIG. 9, the modifiable condition 900a is assigned with a correlated scripted message 901 in a questionnaire. Likewise, each of the remaining modifiable conditions 900b-900g are correlated with a modifiable script which will be visible and available for modification upon selection of the respective modifiable condition.

As shown in FIG. 9, the AI can generate questions 900 with selectable modifiable conditions 900a-900g and script 901 paired with the selected condition 900b. The AI-analysis 210 can suggest correlated AI-generated scripted messages, for example, script 901, for these suggested outcomes i.e., the modifiable conditions, for example, modifiable condition 900a. In an embodiment, the process may be done without AI, except it will take longer. Systems and methods, according to some embodiments of the present invention, allow the recipients 214 to receive responses with scripted messages, in addition to including AI-generated messages, edited or not edited by the participant staff 204. Some of these are invoked by modifiable condition selection made by the participants 204.

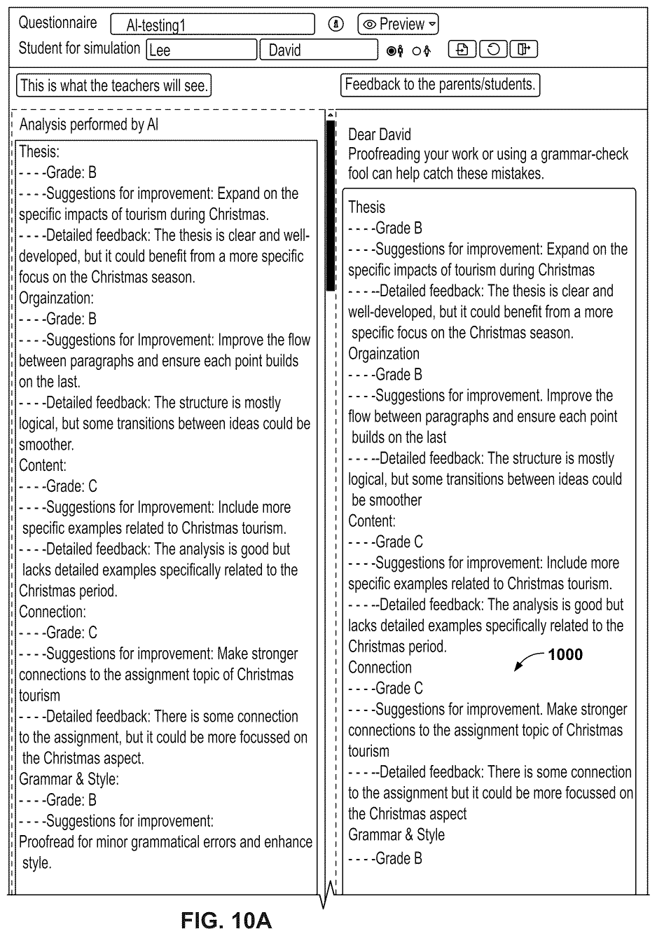

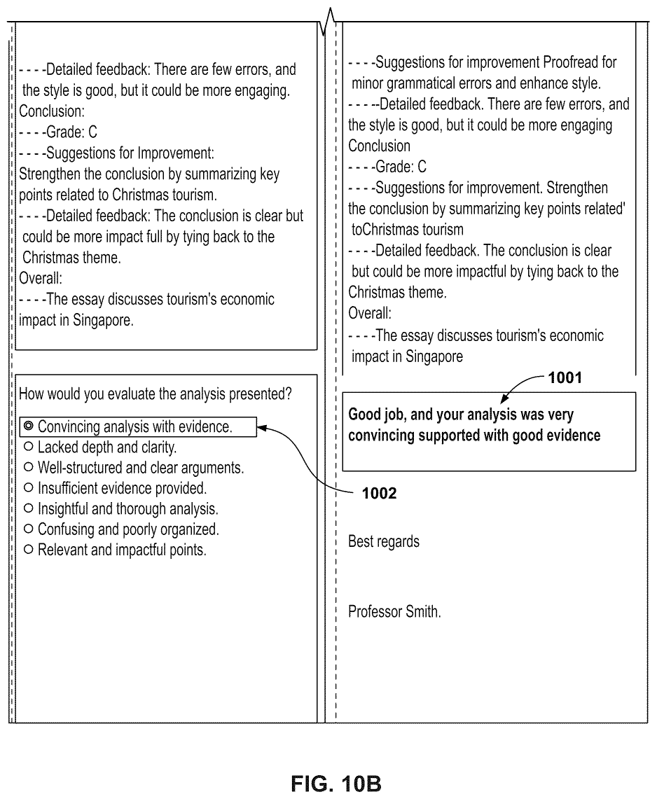

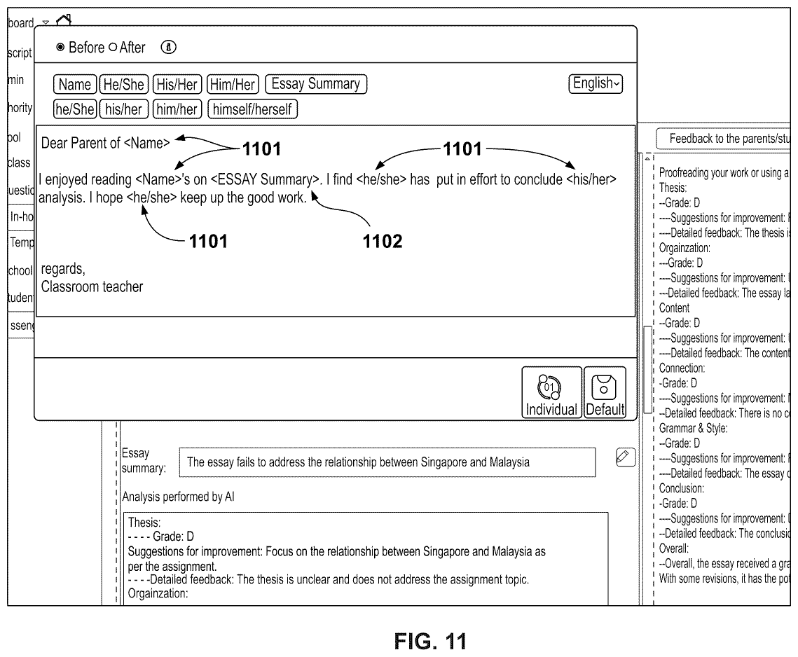

The method 100 further comprises enabling 105 the participant 204 to select applicable modifiable conditions to generate individually tailored responses. The participant 204 is enabled to select one or more of the applicable modifiable. FIGS. 10A-10B exemplarily illustrate a screenshot of a system comprising a feature allowing users to select the most applicable modifiable condition to invoke its corresponding scripted message based on their personal assessment, aided by an AI-analyzed assignment in a questionnaire. The screenshot shows the result 1000 of the AI-analysis of an assignment, the script 1001 paired with the selected condition, and the selected condition 1002 based on the result of an AI-analysis. FIG. 11 exemplarily illustrates a screenshot of a scripted message editor 211a inside the questionnaire editor 211 that facilitates a grammar facility. The scripted message editor 211a facility allows grammar 1100, 1101 to be inserted into the body of the scripted message, enabling the system to automatically make grammatical decisions based on factors such as the recipient's gender 1100, name 1101, the date of the report, and AI-generated content, a dynamic variable 1102 related to the recipients, etc. This grammar facility is essential to ensure that the scripted are more personal and do not appear as machine language.

It should be note that the method 100 may be executed by either a privileged participant 204, AI-analysis 210, regardless of the total number of steps in the method 100.

FIG. 6 exemplarily illustrates a screenshot illustrating that AI-generated content can be incorporated into a non-AI-generated scripted message in the questionnaire. Scripted messages can be paired with some AI-generated or non-AI-generated conditions, as shown in FIG. 6. Within a questionnaire, items can be either non-AI-generated, AI-generated or a mixture of both. For example, as shown in FIG. 6, a dynamic variable “Essay Summary” 501 can be incorporated in the non-AI-generated or manually crafted script 600.

FIG. 12 exemplarily illustrates a screenshot of a questionnaire that illustrates that users can select an exception function by designating which recipients apply to a particular tailored of conditions, whether AI-generated or non-AI-generated. These conditions only apply to some recipients, ensuring participants do not waste time on non-applicable items. As shown in FIG. 12, the participant can input or modify a modifiable condition by providing an input to the field 1202. The participant can also add a new modifiable condition by pressing on the “+” symbol 1203. Likewise, the participant can remove an existing modifiable condition by pressing on the “−” symbol 1204.

As explained above, the enterprise solution system 200 allows the participant to modify, add or delete each of the correlated scripts for consistency with its modifiable conditions. The enterprise solution system 200 may receive inputs from the participant via the participant communication device for allowing the participant to modify, add, and/or delete each of the correlated scripts for consistency with its modifiable conditions. The enterprise solution system 200 may further facilitate evaluation and insertion of grammar, AI-generated content, dynamic variables, and supplemental information into the correlated scripts. The supplemental information may comprise additional recipient-related information. In an embodiment, either the participant or the AI-analysis 210 facilitate the evaluation and insertion of grammar, AI-generated content, dynamic variables, and supplemental information into the correlated scripts. In an embodiment, the enterprise solution system 200 may generate 110 dynamic variables for inclusion in the questionnaire. Some scripts in the questionnaire will be incorporated with grammar insertion, non-AI-generated content, or AI-generated content, to merge with individual credentials during execution. AI can be deployed to expedite this process.

Some questions, conditions, and condition scripts can be non-AI-generated, although AI can be deployed to expedite the process. Furthermore, all of the above components can be a part of the questionnaire.

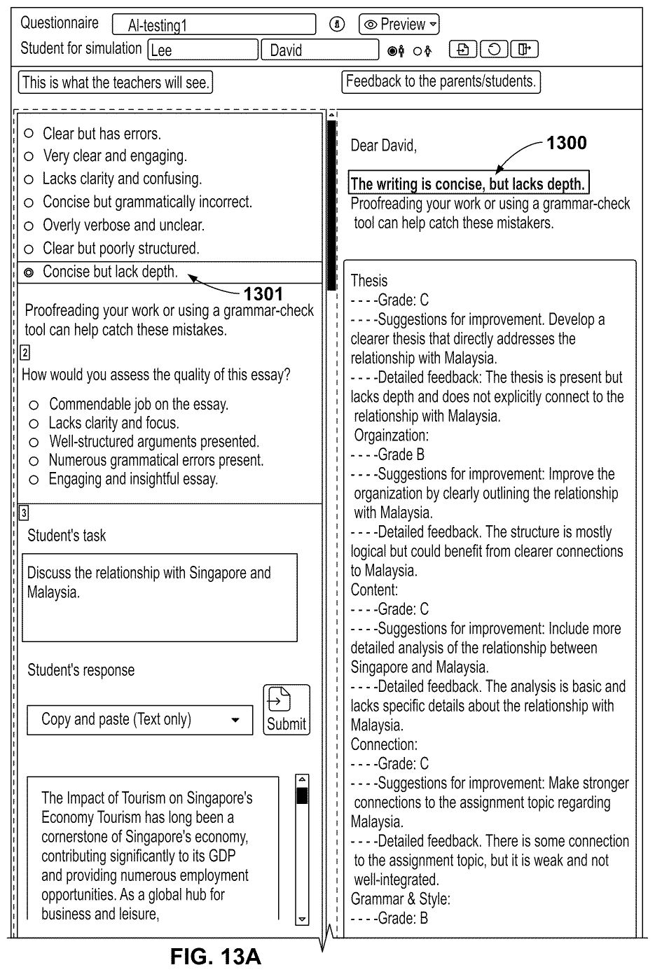

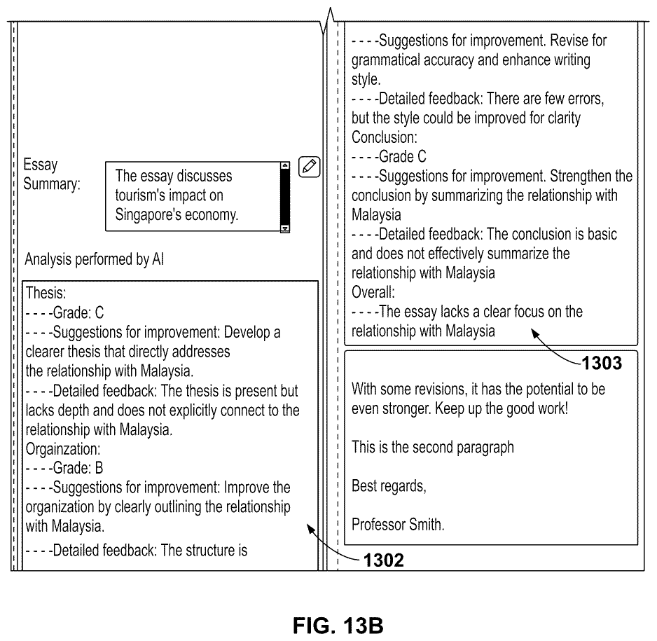

Once the questionnaire is completed, users can use it to analyze entries and generate responses. It can be merged with recipients'credentials to rapidly generate analysis results of entries and individually tailored response messaging at scale. FIGS. 13A-13B exemplarily illustrate a response, which is a scripted message 1300 generated by a selected condition 1301 in a questionnaire. The selected condition 1301 may be an AI-generated condition and selection of this condition generates an AI-generated script 1300 on the right, as shown in FIGS. 13A-13B. Also, as shown in FIGS. 13A-13B, the AI analyzes entries against the benchmark provided. The AI-analysis results 1302 generated are shown on the left. AI-analysis results 1302 can be incorporated into either non-AI-generated or AI-generated responses. The AI-analysis results 1302 may be incorporated into either non-AI-generated or AI-generated responses 1303, as shown in FIGS. 13A-13B.

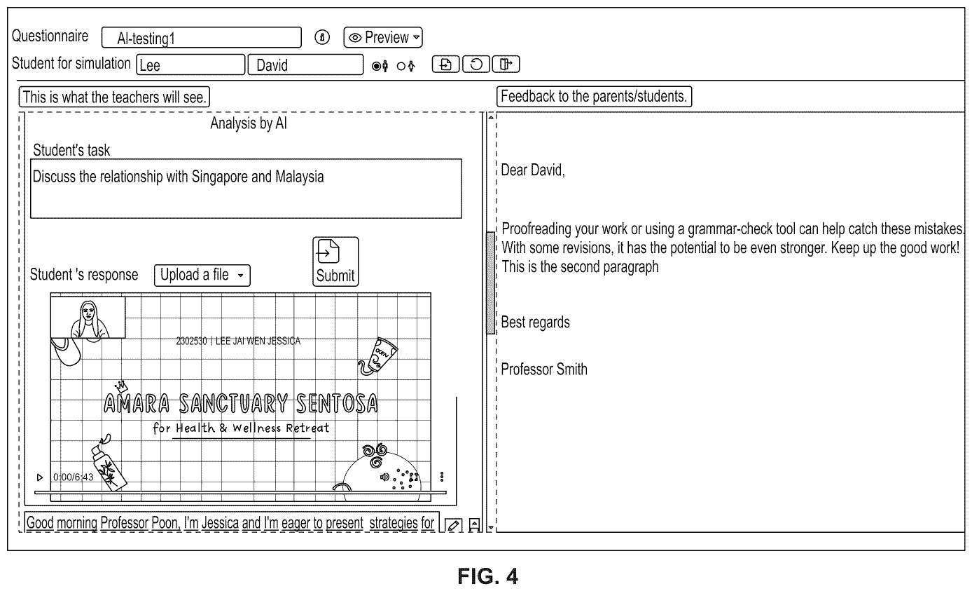

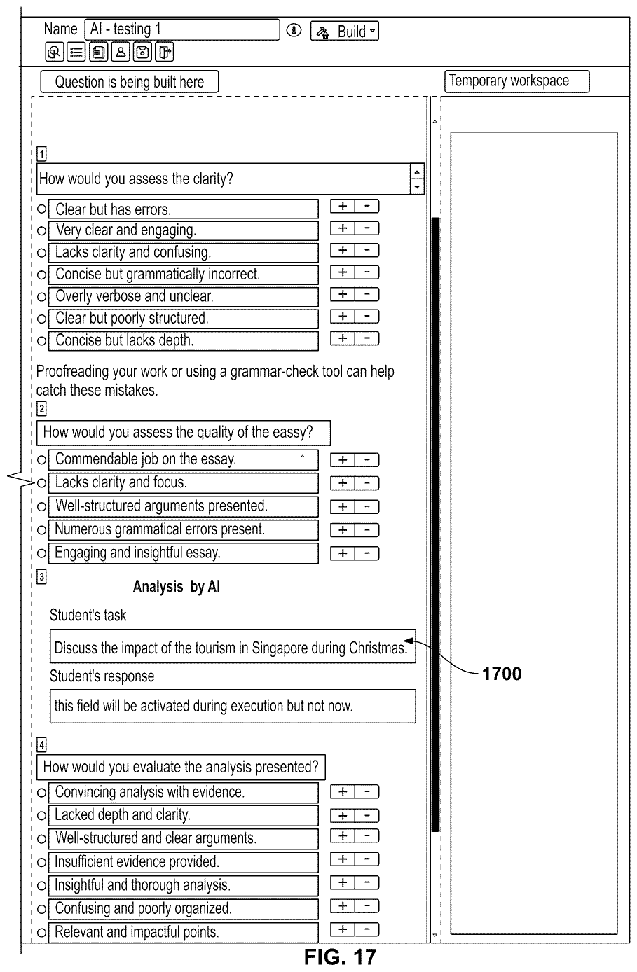

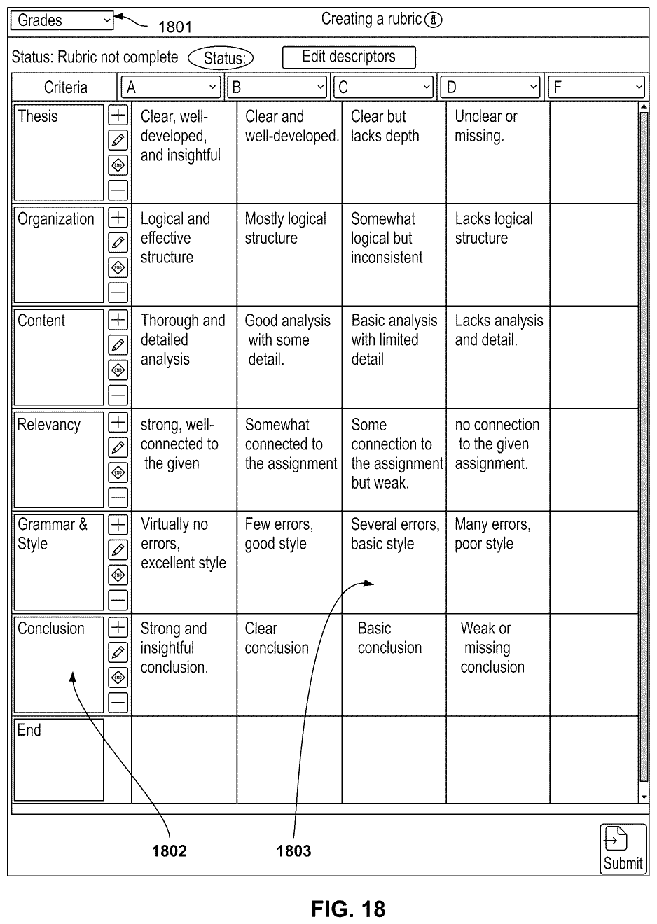

FIG. 1B exemplarily illustrates a method 106 of using the questionnaire to generate an individually tailored response to a recipient. As shown in FIG. 1B, the method 106 further comprises a step of using 106a the questionnaire to generate an individually tailored response to the recipient 214. The step of using 106a the questionnaire to generate an individually tailored response to the recipient 214 comprises receiving 106b recipient entries originating from the recipient. A questionnaire configuration module 209, as shown in FIG. 2, is configured to receive entries originating from the recipient 214. FIG. 4 exemplarily illustrates a screenshot illustrating that a recipient entry, for example, an assignment, can be submitted for AI analysis in a questionnaire. As exemplarily illustrated in FIG. 4, the assignment is a video assignment that is uploaded for AI analysis. The step of using 106a the questionnaire to generate an individually tailored response to the recipient further comprises making a request 106c to provide the content for the response. In an embodiment, the request may be made to the participant 204 via the questionnaire to one of provide and transfer the content for the response. The participant 207 may submit an assignment benchmark during the questionnaire execution in the enterprise solution system 200 for AI analysis, as shown in FIG. 17. The enterprise solution system 200 receives 106d, via a user interface 217a of a recipient communication device 217, one or more entries. As explained above, these entries may be provided by the recipient. The participant 204 may upload the received entry via the user interface 207a of the participant communication device 207. The user interface 207a may be a graphical user interface 207a, as shown in FIG. 2, to input or upload the content corresponding to the response draft 300 to the enterprise solution system 200 and to receive output. As shown in FIG. 17, the participant 204 inputs 1700 the assignment to allow AI to use it as benchmark for response. FIG. 18 exemplarity illustrates that a benchmark configurator 213 is facilitated for the participant 204 to configure a benchmark for AI analysis. The participant 204 can select 1800 what type of rubric, which is a type of benchmark, for response. The system allows the participants to configure 1802 the criteria they want. The system also allows 1803 the participants to define the definition for each descriptor as responding standards. The enterprise solution system 200 processes 106e the one or more entries using an AI-analysis 210 configured to evaluate content. The method 106 further comprises generating 106f a response output corresponding to the one or more entries by the AI-analysis 210. The generated response may be a grading output.

The method 106 further comprises requesting 106g via the questionnaire to determine if it is necessary to integrate and where in the questionnaire to integrate the recipient-related grammar, the one or more dynamic variables, the supplemental information, and/or the AI-generated content into any type of the modifiable script. In an embodiment, the requesting 106g via the questionnaire is facilitated by either the participant 204 or the enterprise solution system 200. The method further comprises generating 106h the individually tailored response to the recipient 214. The individually tailored response is generated using the received input associated with the recipient 214.

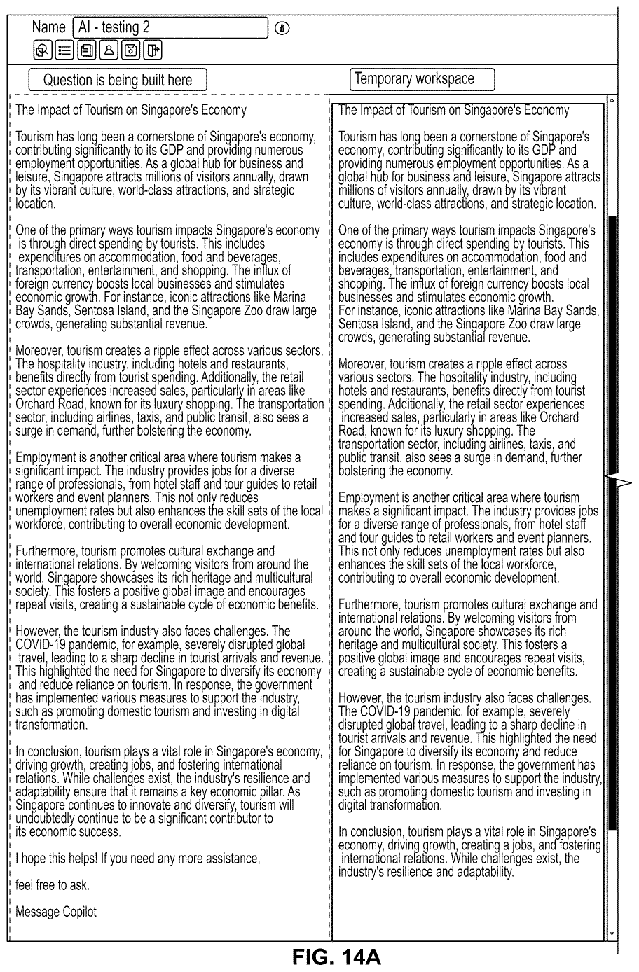

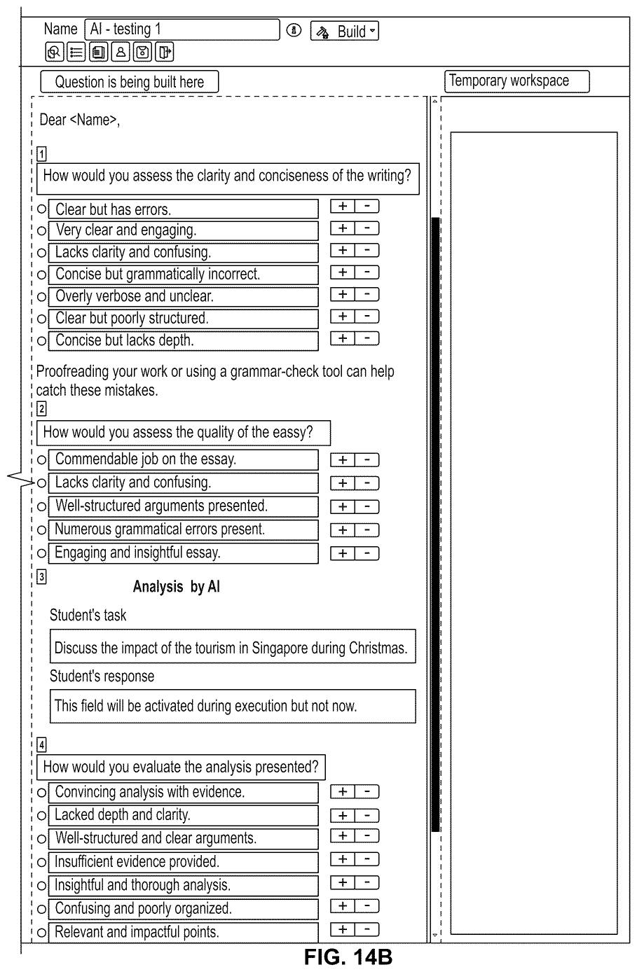

FIGS. 14A-14B exemplarily illustrate a response draft that can be transformed into a questionnaire by a function (e.g., build editor 212) expeditiously with the help of AI. AI functions in the AI-analysis 210 help transforming a response draft into a questionnaire. In an embodiment, the enterprise solution system 200 uses AI-analysis 210 along with a function, for example, a build editor 212 for transforming the content into the one or more modifiable conditions in the questionnaire. As shown in FIGS. 14A-14B, the response draft is shown on the left which is then transformed into the one or more modifiable conditions shown on the right. The response draft is provided by the participants.

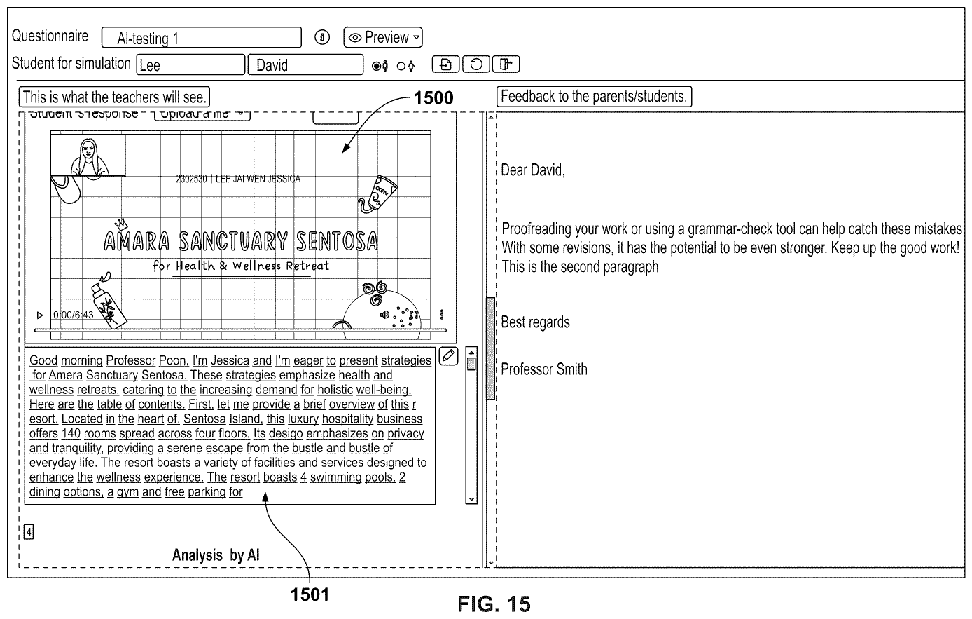

In an embodiment, a video assignment or an audio assignment may be uploaded to the enterprise solution system 200. The enterprise solution system 200 or the AI-analysis 210 use an AI analysis function to transcribe the uploaded video assignment or the audio assignment. AI analysis can also generate images from the video assignments. FIG. 15 exemplarily illustrates that an AI analysis function, performed by the AI-analysis 210, successfully produces images and transcribes an uploaded video assignment 1500 when a questionnaire is executed, paving its way to further AI analysis. The transcriptions 1501 of the uploaded video 1500 assignment may be displayed to the participant for review.

FIG. 16 exemplarily illustrates that participants prepare recipients'credentials, which are merged with a questionnaire to produce enhanced, individually tailored response messaging. The recipients', for example, students' credentials are entered by the participant, and the credentials are merged into a questionnaire to produce individually tailored response messaging in scale.

FIG. 17 exemplarily illustrates that a participant submits the assignment benchmark during the questionnaire execution in the enterprise solution system for AI analysis. As shown in FIG. 17, a participant inputs 1700 the assignment to allow AI to use it as benchmark for responding. FIG. 18 exemplarity illustrates that a benchmark configurator 213 is facilitated for the participant to configure a benchmark for AI analysis. The participant can select 1800 what type of rubric, which is a type of benchmark, for responding. The system allows the participants to configure 1802 the criteria they want. The system also allows 1803 the participants to define the definition for each descriptor as responding standards.

As shown in FIG. 2, the enterprise solution system 200 further comprises the AI-analysis 210 for AI-assisted grading. The AI-assisted grading may also be performed by the external AI-analysis 210. The enterprise solution system 200 receives one or more entries provided via a user interface of a communication device. The communication device may be the recipient communication device 217 and the user interface is the user interface of the recipient communication device 217a. The enterprise solution system 200 processes the one or more entries using the AI-analysis 210, to evaluate content and generate a response output corresponding to the one or more entries. The response output may be a grading output.

A non-transitory computer-readable medium comprising programming instructions that, when executed by one or more processors, cause the processors to implement the method 100 illustrated in FIG. 1A.

Systems and methods, according to some embodiments of the present invention, also allow a participant to design the questionnaires to perform consistent internal management quality control. Participants can pre-select responding content for the users to allow them to share information with the students. The participants can configure which particular information can or cannot be shared with the selected recipients. AI can be deployed to expedite this process.

Systems and methods, according to some embodiments of the present invention, allow scripted messages generated by AI for expedition. When the participant selects one or more conditions for a particular recipient, the system automatically triggers the optionally correlated scripted message to all parties concerned. Parties concerned can be more than the recipients, who can use the information to gain insight.

Systems and methods, according to some embodiments of the present invention, allow the participant to use AI to expedite question designs in the questionnaires based on guidelines. If the users feel more comfortable not to use AI, he can provide them to the system.

Systems and methods, according to some embodiments of the present invention, allow the participant to decide whether to use AI to pre-configure which conditions require immediate attention from the recipient. The paired scripted messages of these conditions are sent as an alert to capture the recipient's immediate attention.

Different students have different needs. Sometimes, not all the response messaging within the questionnaires applies to every recipient. To save classroom teachers' time, the participant can configure which question is relevant to which recipient so that users can skip the irrelevant parts of the questionnaire to particular recipients.

Systems and methods, according to some embodiments of the present invention, allow the participant staff to pre-select students from a classroom roll call for AI-generated or non-AI questions or instructions within questionnaires so that either the non-selected students can be skipped, or the selected students can be skipped.

Systems and methods, according to some embodiments of the present invention, allow the participant staff to configure the questionnaires in which selected AI or non-AI-generated conditions can skip ahead with subsequent questions.

Systems and methods, according to some embodiments of the present invention, allow the participants to configure choices of recipient-related grammar to automatically adapt to scripted messages based on various parameters, such as the genders of the students, dates, dynamic variables, etc. Students are offered an online facility to view these scripted messages with embedded grammar. AI can be deployed to expedite this configuration. Dynamic variables can be integrated into the script, ensuring each script is uniquely tailored based on the varying input data.

Systems and methods, according to some embodiments of the present invention, are exemplary and illustrated at a high level; AI can be deployed to quickly transform response drafts into the one or more modifiable conditions in the questionnaire. While this process can also be done without AI, it would take longer.
1. The Questionnaire Creation process may include various steps without AI, but AI can be deployed at each stage to enhance productivity.
   A. to enhance productivity and transform a portion or the entire response drafts provided to the system. It does this by considering the unique characteristics of each context in the response draft and transforming it into part of the questionnaire by suggesting various modifiable conditions. These conditions can be represented in various formats, including multiple-choice, allowing the users to select one or more conditions that apply to various recipients during execution. A correlated script can be provided for each condition.
   B. to determine where in the questionnaire to insert grammar, AI-generated content, or any recipient-related information. This ensures that a response generated by the questionnaire can be merged with the recipients'related information.
   C. to perform a manual analysis of entries. Benchmarks for manual analysis can be provided to the system during the transformation process, postponed until the questionnaire is executed, or at any time in the system.
   D. to determine where in the transcript to insert gender-specific grammar, the recipient's name, AI-generated content, or any recipient-related information. This ensures that a response generated by the questionnaire can be merged with the recipients' related information.
   E. to provide scripts by inserting grammar, or non-AI-generated content. This ensures that a response generated by the questionnaire can be merged with the recipient's related information.
2. The Questionnaire Execution process can generate individually tailored responses for recipients and may include various steps without AI. However, AI can be deployed at each stage to enhance productivity.
   A. The questionnaire may request the users to select the applicable conditions applicable to the recipients to generate a correlated script message.
   B. The questionnaire can request users to provide benchmarks for analysis of entries.
   C. The questionnaire can request users to analyze entries in the response.
   D. The questionnaire can request the users provide non-AI-generated scripted messages with grammar, and AI-generated content inserted.
   E. The questionnaire can request users to provide scripted messages in the response.
   F. The questionnaire can request users to include non-AI-generated content in the response.
   G. The questionnaire can request users to provide entries in the response.

The method and the system disclosed herein are not limited to a particular computer system platform, processor, operating system, or network. In an embodiment, one or more aspects of the method and the system disclosed herein are distributed among one or more computer systems, for example, servers configured to provide one or more services to one or more client computers, or to perform a complete task in a distributed system. For example, one or more aspects of the method and the system disclosed herein are performed on a client-server system that comprises components distributed among one or more server systems that perform multiple functions according to various embodiments. These components comprise, for example, executable, intermediate, or interpreted code, which communicate over a network using a communication protocol. The method and the system disclosed herein are not limited to be executable on any particular system or group of systems, and are not limited to any particular distributed architecture, network, or communication protocol.

It is apparent in different embodiments that the various methods, algorithms, and computer programs disclosed herein are implemented on non-transitory computer readable storage media appropriately programmed for computing devices. The non-transitory computer readable storage media participate in providing data, for example, instructions that are read by a computer, a processor or a similar device. In different embodiments, the “non-transitory computer readable storage media” also refer to a single medium or multiple media, for example, a centralized database, a distributed database, and/or associated caches and servers that store one or more sets of instructions that are read by a computer, a processor or a similar device. The “non-transitory computer readable storage media” also refer to any medium capable of storing or encoding a set of instructions for execution by a computer, a processor or a similar device and that causes a computer, a processor or a similar device to perform any one or more of the methods disclosed herein. Common forms of the non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The foregoing examples have been provided merely for explanation and are in no way to be construed as limiting of the method and the system disclosed herein. While the method and the system have been described with reference to various embodiments, it is understood that the words, which have been used herein, are words of description and illustration, rather than words of limitation. Furthermore, although the method and the system have been described herein with reference to particular means, materials, and embodiments, the method and the system are not intended to be limited to the particulars disclosed herein; rather, the method and the system extend to all functionally equivalent structures, methods and uses, such as are within the scope of the appended claims. While multiple embodiments are disclosed, it will be understood by those skilled in the art, having the benefit of the teachings of this specification, that the method and the system disclosed herein are capable of modifications and other embodiments may be effected and changes may be made thereto, without departing from the scope and spirit of the method and the system disclosed herein.

I claim:

1. A method of transforming a response draft into a questionnaire, performed by an enterprise solution system comprising one or more processors and a memory storing instructions executable by the one or more processors, the method comprising:
accepting input content corresponding to a whole or a partial part of the response draft for transformation into the questionnaire;
providing the content at one of a plurality of levels of granularity;
obtaining one or more modifiable conditions based on the provided content;
providing a plurality of modifiable scripts, each correlated to a respective one of the one or more modifiable conditions; and
enabling the participant to select applicable modifiable conditions to generate individually tailored responses.

2. The method of claim 1 further comprises using the questionnaire to generate an individually tailored response to a recipient, wherein said generation of the individually tailored response to the recipient comprises:
receiving recipient entries originating from the recipient;
requesting, to provide the content for the response;
receiving, via a user interface of a recipient communication device, one or more entries;
processing the one or more entries using an AI-analysis configured to evaluate content;
generating a response corresponding to the one or more entries;
request via the questionnaire to determine if it is necessary to integrate and where in the questionnaire to integrate the recipient-related grammar, one or more dynamic variables, the supplemental information, and/or the AI-generated content; and
generate the individually tailored response to the recipients.

3. The method of claim 1, wherein providing the content comprises at one of the plurality of granularity levels comprises providing one of a sentence, a paragraph, a plurality of sentences, and the entire response draft.

4. The method of claim 1, wherein transforming the provided content into the one or more modifiable conditions comprises:
enabling participant modification of the one or more modifiable conditions;
allowing the participant to modify, add, and/or delete each of the correlated scripts with its modifiable conditions, comprising:
the enterprise solution system receiving inputs via a participant communication device.

5. The method of claim 1, wherein the response draft comprises one or more response statements to the recipient about the recipient entries, wherein each response statement provides response about at least one of a plurality of aspects of the recipient entries.

6. The method of claim 1, wherein the enterprise solution system accepts the input content corresponding to the response draft as media content, and wherein the input content corresponding to the response draft is provided to the enterprise solution system via a participant communication device.

7. The method of claim 2, wherein the determination of the necessity and where in the questionnaire to integrate recipient-related grammar, AI-generated content, the dynamic variables, and supplemental information into any type of the modifiable script is facilitated by one of the participant and the enterprise solution system.

8. The method of claim 1, wherein the method is executed by one of a privileged participant and the AI-analysis, regardless of the total number of steps.

9. An enterprise solution system for transforming a response draft into a questionnaire, comprising:
one or more processors and a memory storing instructions executable by the one or more processors to perform functions comprising;
accepting input content corresponding to a whole or a partial part of the response draft for transformation into the questionnaire;
providing the content at one of a plurality of levels of granularity;
obtaining one or more modifiable scripts, each correlated to a respective one of the one or more modifiable conditions; and
enabling the participant to select applicable modifiable conditions to generate individually tailored responses.

10. The enterprise solution system of claim 9, wherein the enterprise solution system uses the questionnaire to generate an individually tailored response to a recipient by:
receiving recipient entries originating from the recipient;
requesting, to provide the content for the response;
receiving, via a user interface of a recipient communication device, one or more entries;
processing the one or more entries using an AI-analysis configured to evaluate content;
generating a responses corresponding to the one or more entries;
request via the questionnaire to determine if it is necessary to integrate and where in the questionnaire to integrate the recipient-related grammar, one or more dynamic variables, the supplemental information, and/or the AI-generated content; and
generate the individually tailored response to the recipients.

11. The enterprise solution system of claim 9, wherein the input content corresponding to the response draft is provided to the enterprise solution system via a user interface of a participant communication device connected to the enterprise solution system via a network.

12. The enterprise solution system of claim 9, wherein the enterprise solution system enables participant modification of the one or more modifiable conditions by allowing the participant to modify, add, and/or delete each of the correlated scripts with its modifiable conditions, wherein the enterprise solution system receives inputs from the participant via a participant communication device to modify, add, and/or delete each of the correlated scripts.

13. The enterprise solution system of claim 10, wherein the recipient provides entries via a user interface of the recipient communication device via a network.

14. The enterprise solution system of claim 9, wherein the enterprise solution system accepts input content corresponding to the response draft.

15. The enterprise solution system of claim 9, wherein the enterprise solution system uses a function and the AI-analysis for transforming the content into the one or more modifiable conditions.

16. The enterprise solution system of claim 9 further comprising a questionnaire editor and a scripted message editor inside the questionnaire editor, wherein the scripted message editor facilitates a grammar facility by allowing grammar to be inserted into body of the scripts, enabling the enterprise solution system to automatically make grammatical decisions based on factors comprising the recipient's gender, name, the date of the report, and AI-generated content.

17. The enterprise solution system of claim 9 further comprising a benchmark configurator for the participant to configure a benchmark for AI analysis.

18. The enterprise solution system of claim 9 further comprising AI-assisted grading using the AI-analysis, comprising:
receiving one or more entries provided via a user interface of a communication device;
processing the one or more entries using the AI-analysis configured to evaluate content; and
generating a response corresponding to the one or more entries.

19. A non-transitory computer-readable medium comprising instructions that, when executed by one or more processors, cause the processors to:
accepting input content corresponding to a whole or a partial part of the response draft for transformation into the questionnaire;
providing the input content at one of a plurality of levels of granularity;
obtaining one or more modifiable conditions based on the provided content;
providing a plurality of modifiable scripts, each correlated to a respective one of the one or more modifiable conditions; and
enabling the participant to select applicable modifiable conditions to generate individually tailored responses.
